(19) United States
(12) Patent Application Publication
(10) Pub. No.: US 2015/0100479 A1
(43) Pub. Date: Apr. 9, 2015

(54) SYSTEM FOR MONITORING THE COMPLIANCE RELATIONSHIPS OF BANKING ENTITIES WITH VALIDATION, REROUTING, AND FEE DETERMINATION OF FINANCIAL TRANSACTIONS

(71) Applicants: Avi Jorisch, Washington, DC (US); Paul Ratcliffe, Broadlands, VA (US)

(72) Inventors: Avi Jorisch, Washington, DC (US); Paul Ratcliffe, Broadlands, VA (US)

(21) Appl. No.: 14/511,082

(22) Filed: Oct. 9, 2014

Related U.S. Application Data
(60) Provisional application No. 61/888,747, filed on Oct. 9, 2013.

(51) Int. Cl. G06Q 30/00; G06Q 20/38

(52) U.S. Cl. CPC G06Q 30/018; G06Q 20/38
USPC 705/39

(57) ABSTRACT

A system and method for validating a given wire or financial transaction to determine if the destination bank or any connecting or correspondent banks have a direct or indirect relationship with an illicit entity and, if an illicit relationship is identified, the system attempts to reroute the transaction along a compliant path. Such indirect illicit relationship may be set to require at least two degrees of separation and may be user or bank defined depending on their risk tolerance. The rerouted compliance path may identify multiple paths and rank and prioritize that paths based on risk tolerance, associated fees of the banking touch points, and can automatically approve reroutes or display paths to the user for selection. Further, the system allows banks to set and can then determine any compliance fee splits amongst all entities that may receive a portion of the fee and any adjustments from any rerouted paths.

### CROSS REFERENCE TO RELATED APPLICATION

This application claims priority to U.S. Provisional Patent Application 61/888,747 filed Oct. 9, 2013.

### BACKGROUND OF THE INVENTION

1. Field of the Invention

The invention, in general, relates to a system and method for monitoring the banking relationships of banking entities, validating financial transactions for compliance, rerouting financial transactions to avoid non-compliance, and determining and initiating appropriate fee allocation.

2. Background of the Invention

When a bank needs to conduct a foreign financial transaction and the bank does not have a branch in the foreign country, it often transacts with a local bank to supervise its financial affairs in that foreign country and essentially act as its agent. These correspondent banks are then empowered to provide credit, deposit, collection, clearing, and payment services to customers in the main bank's name. This relationship allows a bank to conduct business in a given country without needing a physical presence in that country.

Correspondent banks also provide access to foreign currencies and local markets. In addition, if the banks do not have a direct relationship with a local bank they may need to interact with one or more connecting correspondent banks to create a chain of banks to transact in a certain country or location.

However, banking institutions have increasing regulations, laws, and market pressure to avoid any business relationships with illicit banking entities. As an example, the 2010 Comprehensive Iran Sanctions, Accountability, and Divestment Act (CISADA) requires U.S. banks to know not only who their customer is (direct correspondent bank), but who their customer's customer is (their correspondent bank's correspondent bank). Further, US Banks will have to certify to the US government that they and their customers have no direct or indirect business ties to designated banks or illicit entities, as defined by the U.S. and possibly other governments. In order to meet this demand, banking entities must know who their banking partners are conducting business with to determine if the banking partner has any illicit banking relationships or relationships with illicit banks

Therefore, there is need for a system and method for mapping and monitoring the banking relationships of banking entities and their separation from illicit banking entities. The assignee of the present invention is also the assignee of U.S. patent application Ser. No. 14/462,467 filed on Aug. 18, 2014 and U.S. patent application Ser. No. 13/111,792 filed on May 19, 2011 both of which are incorporated herein by reference in their entirety. In addition, the assignee of the present invention is also the assignee of U.S. patent application Ser. No. 13/092,893 filed on Apr. 22, 2011 which is also incorporated herein by reference in its entirety. Still further, inventor Avi Jorisch is also the author of the book ‘Tainted Money’, published by Red Cell Intelligence Group on Sep. 1, 2009 and the book ‘Iran's Dirty Banking. How the Islamic Republic is Skirting International Financial Sanctions’, published May 20, 2010 by Red Cell Intelligence Group both of which are hereby incorporated by reference in their entirety.

Further, liability for a violation of the regulations can occur with just one instance of an illicit transaction. Since banking relationships change frequently it hinders the ability of banks to remain in compliance. Therefore, each transaction a bank takes with correspondent banks creates a risk for a bank and the banking customer should it be determined it was a non-compliant transaction. Therefore, there exists a need to be able to process transactions on a per transaction basis through a compliance checking system and, if needed, reroute the transaction along a path that is in compliance, mitigates risks and lowers potential fees.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The present invention provides a system which allows banking institutions to process a given wire or financial transaction through a processor and software based system which reviews the destination bank and any connecting or correspondent banks to determine if they have a direct or indirect relationship with an illicit entity and, if an illicit relationship is identified, attempts to reroute the transaction along a compliant path. Such indirect illicit relationship may be two degrees of separation or more and may be user or bank defined depending on the risk tolerance. The administrative user may set or adjust the risk tolerance such as by indicating a minimum degree of separation from an illicit entity. The system may identify multiple compliant paths and rank and prioritize the paths based on risk tolerance, associated fees of the banking touch points, defined preferences, and can automatically approve reroutes or display paths to the user for selection. Further, the system can run all the rerouted touch points through standard direct compliance checks such as an OFAC (Office of Foreign Assets Controls) check.

A second object of the present invention is to provide a system which allows a bank to process a given wire or financial transaction through a system which determines if the destination bank or any connecting or correspondent banks have a direct or indirect relationship with an illicit banking entity and determines any associated transaction and/or compliance fee associated with the transaction. Such transaction or compliance fees may be split between the various banking entities and the compliance checking or monitoring system. The compliance fee determination may include adjustments based on the number of touch points, reroutes, percentage splits and other factors. Further, the fee(s) may be applied by both the transmitting financial institution and the receiving financial institution. The fee(s) may be determined with each transaction, in periodic batch processing, and payments or splits may be processed from the funds when wired or charged as a fee on top of funds wired, post processing either as a per transaction basis or in batch processing (i.e. nightly or weekly).

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 provides a system diagram of the present invention.

FIG. 2 provides a flow diagram of the steps for creating a correspondent banking database with illicit banking designations.

FIG. 3 provides a flow diagram of the steps for validating a financial wire transaction and rerouting a financial transaction for compliance.

FIG. 4 provides a flow diagram of the steps for running a financial compliance transaction with fee determination.

FIG. 5 provides a relationship diagram for path determination of a financial transaction of the present invention.

### DETAILED DESCRIPTION OF EXEMPLARY EMBODIMENTS

Particular embodiments of the present invention will now be described in greater detail with reference to the figures.

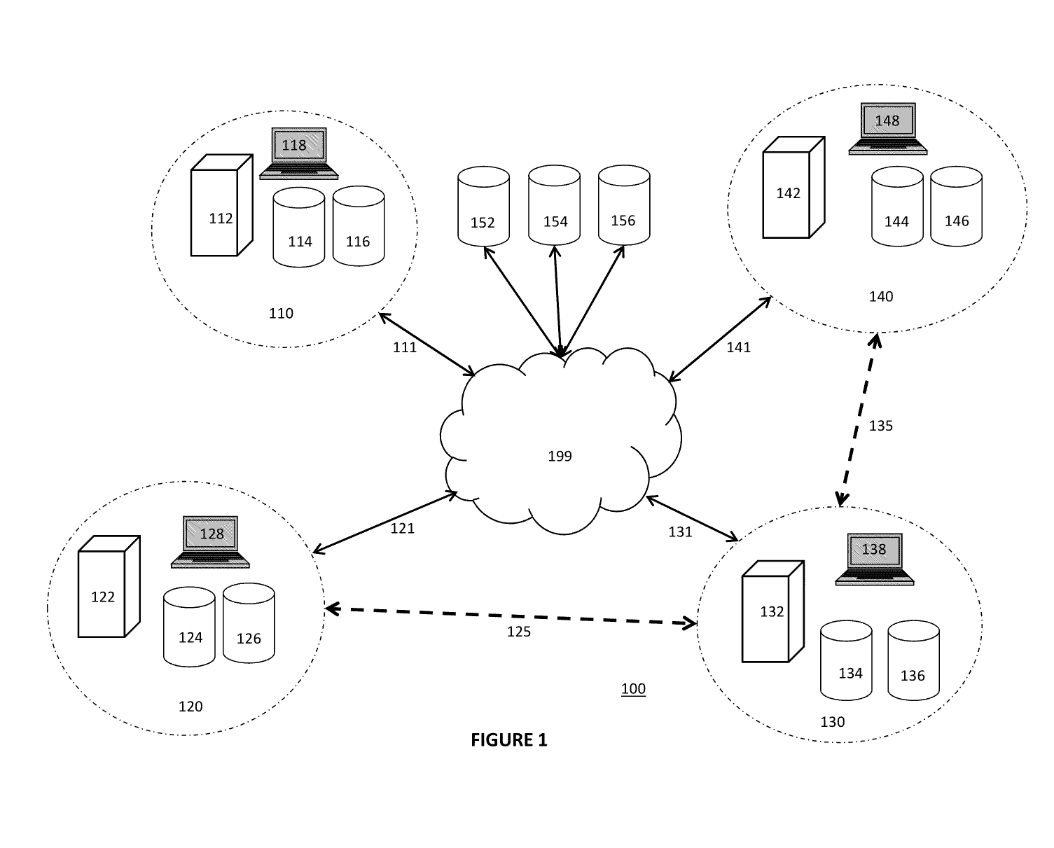

FIG. 1 illustrates a system diagram of the present invention and provides various computers, servers, and databases which are capable of communicating through networks of through the internet 199 or other communication paths. Specifically, the system provides one or more local networks 110, 120, 130, 140 which may be the networks associated with one or more banking institutions or a banking compliance software entity. The banking compliance software network 110 may include one or more servers 112 in communication with one or more databases 114, 116 and one or more tablets, PCs, or other processors 118. The server 112 includes one or more programs, software applications or code capable of operating the banking compliance system to determine banking relationships, degrees of separation, identifying illicit banking entities with a database, validate transactions, reroute transactions which are determined to be out of compliance, fee determinations and various other aspects as described herein.

The banking compliance software network 110 communicates via communication path 111, such as through the internet 199, with various databases 152, 154, 156 and one or more other networks 120, 130, 140 along respective communication paths 121, 131, 141. The databases 152, 154, 156 need not be actual databases but may be data sources, content scraping, and API access to data relevant to banking relationships and compliance. Such data might include the list of illicit banking entities and the individual people and companies that own or operate the illicit entities. Additional data may include identified banking locations, banking relationships, SWIFT codes and accounts, currency rates, and transaction data.

By way of example, the server 112 includes an application to automatically retrieve updated Banking Data Source data 152, 154, 156 on a daily or periodic basis by requesting and/or retrieving data from one or more banking data sources 152, 154, 156. The banking data would be transmitted to server 112 for processing. Such data would primarily consist of available banking data sources (BDS) which might include correspondent banking relationships between financial institutions (including account data), Society for Worldwide Interbank Financial Telecommunication (SWIFT) data, Bank Identification Codes (BICs), bank account numbers, bank beneficial ownership information, companies owned by the financial institution, the location(s) and jurisdiction(s) of operation, credit ratings, ownership type, name of regulator, and type of financial services provided to customers. Such sources might include Dun and Bradstreet reports, Transunion, Equifax, Experian, and other applicable banking and credit data.

In one embodiment, the compliance checking software is installed on server 112 and financial transactions at a given banking entity are sent from the bank network 120, 130, 140 via the internet to the compliance company network 110. The transactions are then processed by the compliance software resident on the one or more servers 112. The compliance check and other related aspects will be discussed in more detail below.

In a second embodiment, the compliance software is installed on the servers 122, 132, 142 of one or more banking entities. The compliance software on servers 112 and updated data 114, 116 are updated by the compliance entity system 110 and transmitted to the banking entity's system 120, 130, 140. By having the compliance checking and rerouting software installed locally in the banking network 120, 130, 140 the banking entities do not need to disclose or transmit sensitive transaction data outside of their network 120, 130, 140. In this second embodiment, the banks' wire transactions, such as international financial wire transactions, can be processed by the compliance checking software resident on the local server 122, 132, 142 within the network 120, 130, 140.

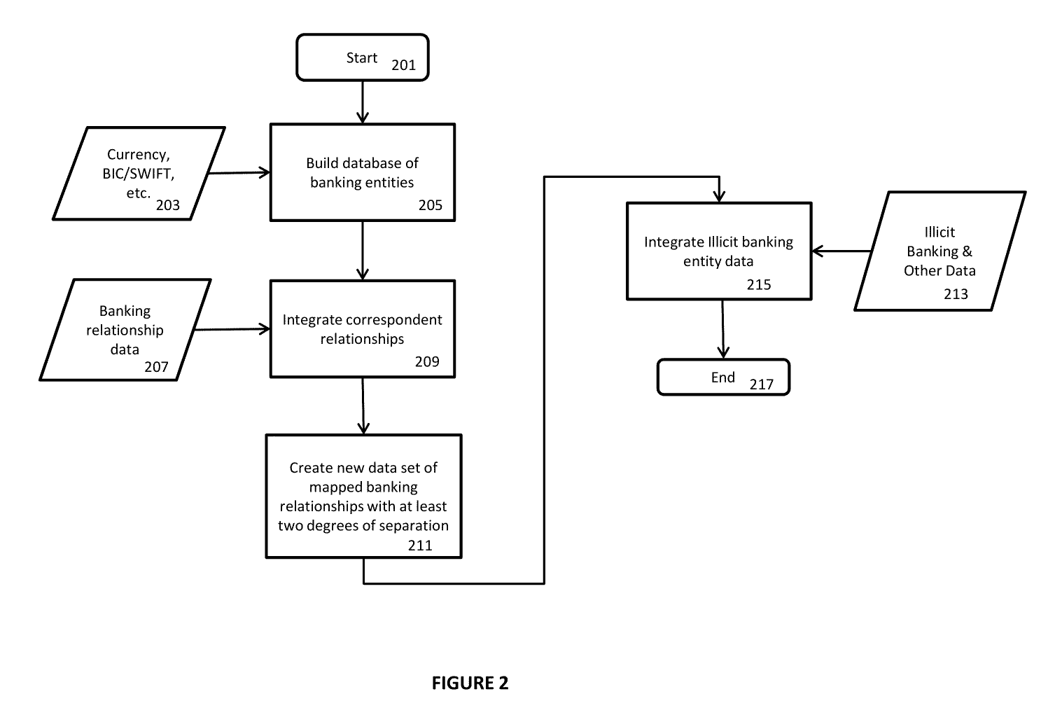

The compliance software resident on the servers, 112, 122, 132, 142 is in communication with the compliance database and map 114, 124, 134, 144 which will be described in more detail in conjunction with FIG. 2. In addition, additional data 116, 126, 136, 146 such as OFAC data, correspondent banking relationships, transaction fees, percentage splits and other aspects are accessible by the software.

Through the system 100, banks 120, 130, 140 are able to transact business with each other while maintaining compliance with one or more compliance regulations. Specifically, bank 120 may have a direct relationship 125 with bank 130 and an indirect relationship with bank 140 through bank 130s direct relationship 135 with bank 140. However, bank 120 may need to transact with bank 140 such as when a customer of bank 120 needs to wire funds to someone who is a customer of bank 140 (or vice versa). Bank 120 can interact with bank 140 through its correspondent bank 130. In simple terms, bank 120 instructs bank 130 to act on its behalf and to deduct (or receive) funds on its behalf Bank 120 has a bank account within their correspondent bank 130 for bank 130 to remove or deposit funds. The two separated banks 120, 140 may be two or more degrees separated which would require more correspondent or linking banks to conduct the transaction between the separated banks 120, 140.

The mapping of the banking correspondent relationships and identification of illicit banking entities and each banks degree of separation from these illicit banking entities has been previously disclosed by the applicant in: (1) U.S. patent application ser. No. 13/111,792 entitled “System and Method for Mapping and Compliance Monitoring of Banks”; and (2) US patent application Ser. No. 13/092,893 entitled “Method and System for Graphically Determining The Degree of Separation Between Banks In A Correspondent Banking Network”, the teachings of both are incorporated herein in their entirety.

By way of specific example, if Bank 120 needs to wire funds to Bank 140 it would need to interact with its correspondent Bank 130. However, compliance regulations require Bank 120 to make sure that the transaction is compliant. In this instance, Bank 120 would need to make sure that not only are Bank 130 and Bank 140 not illicit banking entities, but that Bank 130 and Bank 140 are not conducting business with an illicit banking entity. The software resident on server 122 (or server 112) would process the transaction information, determine the intended path Bank 120 would normally process based on their correspondent relationships, fewest touch points, preferred banks, lower fees, and would verify each touch point is at least two or more degrees separated from an illicit banking entity. Bank 120 may choose to establish a higher degree of separation, such as three (3) degrees of separation, and the software resident on server 122 (or 112) can integrate such logic into the compliance validation process.

In the event the software resident on server 122 (or 112) determines the intended path is non-compliant, the software can identify alternative paths through alternative correspondent banks and determine if such paths would be in compliance. The system can display the alternative paths to a user on the screen associated with computer 128 for the user to select a path. Alternatively, the software can automatically select the path. Such selection may be based on fewest touch points, preferred banks, lower fees, safest compliant path, or other factors.

The software resident on server 122 (or 112) may also be on the servers of the correspondent bank 130 and the receiving bank 140. Each bank 120, 130, 140 may run their own instance of the software on their servers 122, 132, 142 and transmit, receive, or act as a correspondent bank for a financial transaction, such as a wire transaction, only after they have verified the banks in the path meet compliance standards. With an estimated 500,000 banks globally, and over 7,000 banks in the US alone, banks need a system which can quickly identify problematic banking entities within a transaction path and reroute the transaction or reject the transaction to maintain compliance.

The database build and correspondent mapping process of the present invention will now be described in conjunction with FIG. 2. In Step 201 the system starts by building a database of banking entities 205 through one or more banking data sources 203. The data sources 203 may be public or private data sources and may be provided by the banks themselves as most banks subscribe to one or more data sources. The system, in step 209, is able to access the banking relationship data 207 and uses these data sources 203, 207 to map out a comprehensive list of correspondent relationships between financial institutions (including account data), Society for Worldwide Interbank Financial Telecommunication (SWIFT) data, Bank Identification Codes (BICs), and account numbers. The present invention utilizes various methods and applications to compile and extract the correspondent bank information on each financial institution around the world from the banking data sources 203, 207.

Specifically, the banking data sources 203 identifies each bank and their associated BIC/SWIFT codes and the accounts they have at other banking institutions as well as the accounts in their own bank they manage for other banking entities. The data is used to build the database of banking entities 205 and build out the banking relationship data 207. Through the relationship data, the system creates a 1^{st} degree or direct correspondent relationship 209. The system analyzes each banking institution in the database to identify all of the accounts they have with other banks or accounts they hold for other banks which are considered direct relationships (1^{st} degree) of a given bank (Bank A) to generate the list of direct banks (Bank B1, Bank B2 . . . ) associated with the given bank (Bank A). The system then analyzes the data again to identify all of the accounts each correspondent bank (Bank B1, Bank B2, . . . ) has with other banks (Bank C1, Bank C2, . . . ) or accounts they hold for other banks (Bank C1, Bank C2, . . . ) which are considered 2^{nd} degree banks or 2 degree correspondent banks The system then saves the association of 2 degree correspondent banks (Bank C1, Bank C2 . . . ) in the database as associated with Bank A with 2 degrees of separation. The system can continue to process each relationship level of each bank to determine additional degrees of separation and store the association with the database 211 of the system. Through analysis and use of the information on the accounts each bank has with other banks or accounts each bank holds for other banks, the direct correspondent banking relationships can be determined, and the association of banks within 2 degrees, 3 degrees, and so on can be determined and stored in the database.

In step 211, the information is used to populate a correspondent banking database with, in the preferred embodiment, the following fields: (1) bank name; (2) country (in which the bank is located); (3) designated bank (e.g. UN/US/EU/Other/NA); (4) Type of Designation (e.g. EMD/Terror/Iran/Drugs/NA); (5) Correspondent Banks which are providing correspondent services; (6) correspondent designated (yes/no with Alert status as Green, orange, or Red); (6) currencies provided (USD, EUR, CHF, JPY, etc.); (7) BIC/Swift Code of the financial institution; (8) account number; and (9) the source (BDS, Financial Institution, Other).

The compiled data (step 211), as explained above, processes and stores the association, degrees of separation, or relationships to provide a Correspondent focused database and system. The system of the present invention identifies correspondent entities a bank provides services to and correspondent bank entities a bank receives services from. With the banking information for every financial institution in the world, the system maps out the relationships both forwards and backwards at a minimum or at least two degrees. Additionally, the system is able to utilize information from individual financial institutions to verify correspondent and banking data source information. The direct banking data will either corroborate existing information or provide additional data for inclusion.

In step 215, the banking data information is updated to reflect whether a certain banking entity in the database 211 is illicit. Governments around the world have identified a number of illicit banks and this data 213 is processed by the system to identify and flag the illicit banks within the databases 211 of the system. Further, the system will monitor various data sources and websites that include but are not limited to the following: 1) Treasury Department's Office of Foreign Assets Control (OFAC); 2) Treasury Department's Office of Financial Crimes Enforcement Network (FinCEN); 3) State Department's Office of International Narcotics and Law Enforcement Affairs; 4) European Union's Council; 5) Financial Action Task Force; 6) Egmont Group; and 7) Wolfsberg Group. Illicit or designated banks will be highlighted in the database. The identification of illicit banks is then updated within the database of the present invention. In addition, a status marker may be applied to the correspondent banks

The processing of data through the various steps, routines, and rules can be repeated to determine additional levels of correspondent banking relationships. Thus, the system can be used to generate correspondent banking relationships and potential illicit activity to the 1^{st}, 2^{nd}, 3_{rd}, 4^{th}and 5^{th} level (and beyond, if desired) by repeating the various steps of identifying relationships using the list of correspondent banks from the previous level. Thus, banks and financial institutions can utilize the system to identify appropriate or inappropriate banking relationships, monitor existing relationships, validate transactions on a one off or batch process basis, and identify alternative and compliant transaction paths. Once the correspondent banking database is compiled and/or mapped it can be used to verify compliance and the database build process ends 217. The correspondent banking database can be updated frequently as new banking relationships are identified and correspondent mapping process is repeated so the banking entity relationships and degrees of separation are remapped.

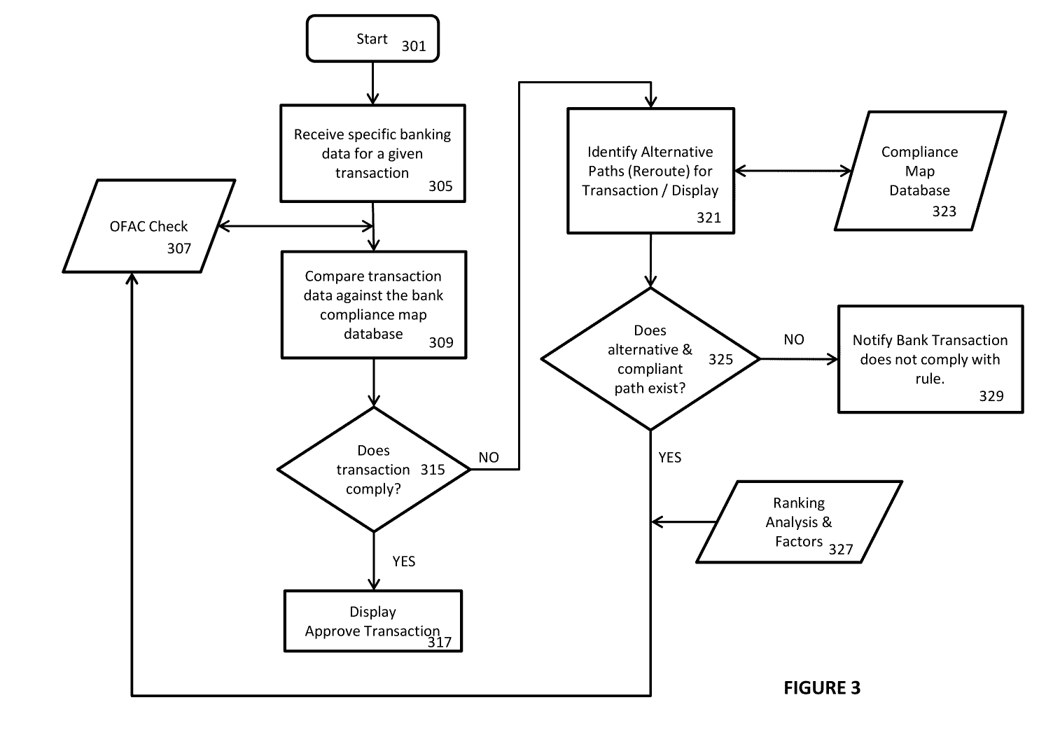

FIG. 3, provides a flow diagram of the systems steps for compliance validation and alternative path analysis of a financial transaction. As previously described, the system and software is capable of processing one or more transactions against the correspondent banking network with illicit bank, illicit owners, and other possible compliance indicators. In step 301 the software or program is initiated. The software receives specific banking data for a given transaction or batch of transactions. Such information would include the sending bank, the receiving bank, any correspondent banks the sending bank might intend to use, the customer, and the recipient. An OFAC check might be conducted in step 307 against an OFAC database on all known touch points. An OFAC check is a direct check to see if the receiving bank, any correspondent banks, the customer, and the recipient are flagged in the OFAC database. OFAC is only a direct check and does not know or identify the relationships of those banks or individuals with other banks or entities to identify if they are doing business with an illicit entity.

In step 309, the system compares the transaction data, such as the sending bank, the receiving bank, any preferred correspondent banks, the customer, and the recipient against the bank compliance map and database and determines one or more paths of correspondent banks the sending bank may use to conduct the wire transaction. Banks may have various filters or selection criteria to determine or select a preferred transaction path such as fewest correspondent bank touch points, preferred correspondent banks, lower fees, safest compliant path, or other factors. Once the preferred path is identified, the system then reviews the relationships of each correspondent bank in the path and the correspondent relationships of the recipient bank to determine if they have any relationships with, or how many degrees they are separated from, illicit banking entities.

In step 315 a determination is made as to whether the transaction complies with any set regulations (i.e. at least 2 degrees of separation from an illicit entity) or any bank defined rules for compliance (i.e. at least 3 degrees of separation and avoid banks in Pakistan). The system is initially set to only find banks along the path which are at least two degrees away from any illicit entity. Meaning, each bank along the path may not be in a correspondent relationship with an illicit entity. As previously mentioned, the system may display in step 317 the path or paths to a user and may employ one or more markers or flags to display approved paths, problematic paths, or problematic touch points or banks in the paths. The display may show the paths in a table form or a graphic illustration showing each link or bank in the path. The display may show a primary path and alternative paths similar to the display methodologies used by mapping software when displaying driving directions.

If the software, in step 315, determines that the initial or preferred path of the transaction would not comply with the set or defined parameters of the compliance check, the system, in step 321, then identifies alternative paths using the compliance map database 323 and the banks correspondent banking network. The alternative paths are then also checked for compliance in step 325 to determine if one or more compliant paths exist. If no compliant paths exist, the system can notify the user that a compliant path does not exist in step 329. In such instance, the bank may elect to overrule the software and process the transaction anyway. If, in step 325, the software does identify one or more alternative paths that are compliant, those paths may be ranked based on one or more factors including fewest touch points, preferred banks, correspondent banking fees, safest or most compliant path, or other factors. All new touch points along the alternative path(s) can also be run through the OFAC check 307 and compared again against the compliance map database, step 309, for approval in steps 315 and 317.

The system and software enable banking entities to identify all banks along a transaction path and review the correspondent banking relationships for each of the banks along the path to avoid using any bank that has a relationship with an illicit banking or financial entity. The software can rank or rate paths, reject paths, and identify alternative or rerouted paths to conduct the transaction. The alternative or rerouted paths may also be ranked or rated based on one or more factors such as least risk or a higher degree of separation, lowest correspondent banking fees or other factors. Ranking the paths based on fees may help to save the customer money or maximize the bank's margin on the transaction fee it charges the customer. The paths, including any rerouted or alternative paths, may be displayed to the user (bank teller or agent). The bank user (teller) may then approve the path or select an alternative or rerouted path. Approval by a bank user can then instruct the system to communicate to the bank's wire transfer system to initiate the instructions for sending or moving the funds. The system may be configured to handle the transmission of funds directly or may generate instructions for the transaction which are then processed by known transaction platforms such as FedWire and ClearWire. Instructions may be placed in the FedWire or ClearWire system or included as part of a typical financial transaction messaging system such as SWIFT. The system can also employ an OFAC check against any new banks in any rerouted paths or alternative paths. Further, the system could identify paths on a one off basis or process and analyze many paths at once.

Further, the system of the present invention does not need to integrate a user approval process and may automatically select a path based upon identification of a compliant path and ranking path factors. Upon identifying an approved transaction path the system can automatically initiate the transfer (without human approval). For instance, the bank admin user can identify they want all paths which are compliant and have a ranking or rating above a certain threshold to be automatically approved. The ranking or rating can be based on degrees of separation, country location or score, total transaction fees and preferences such that the system can calculate a rating.

By way of example, the system can determine a score or rating using a formula such as: Rating=(0.6*DS)+(0.3*TFS)+(0.1*CS)+(0.1*RS) where DS is a degree of separation score, TFS is a total fee score, CS is a country score, and RS is a relationship sore. DS may be a cumulative total or an average of the degrees of separation from an illicit banking entity for each bank in the path (where each bank must have at least a 2 degree separation). TFS may be determined by calculating or adding the cumulative total of all fees in the transaction path and then subtracting the cumulative total from the fee charged to the bank customer to determine the bank's net transaction fee. The CS or country score may be determined by assigning banks located in less desirable countries with a deduction factor (i.e. −0.1), adding all the deductions and subtracting from a base or initial number (i.e. 1). RS may be a relationship score where partner banks may receive an increase factor or bonus (i.e. +0.1), adding all the increased amounts from each bank in the path and adding to a base or initial number (i.e. 1). Further, each factor DS, TFS, CS, and RS can be weighted in the rating formula as a percentage of the total score. For example, in the rating calculation provided above, the DS is weighted 0.6 or 60% of the total score, TFS is weighted 0.2 or 20%, CS is weighted 0.1 or 10%, and RS is weighted 0.1 or 10% for a total of 100%.

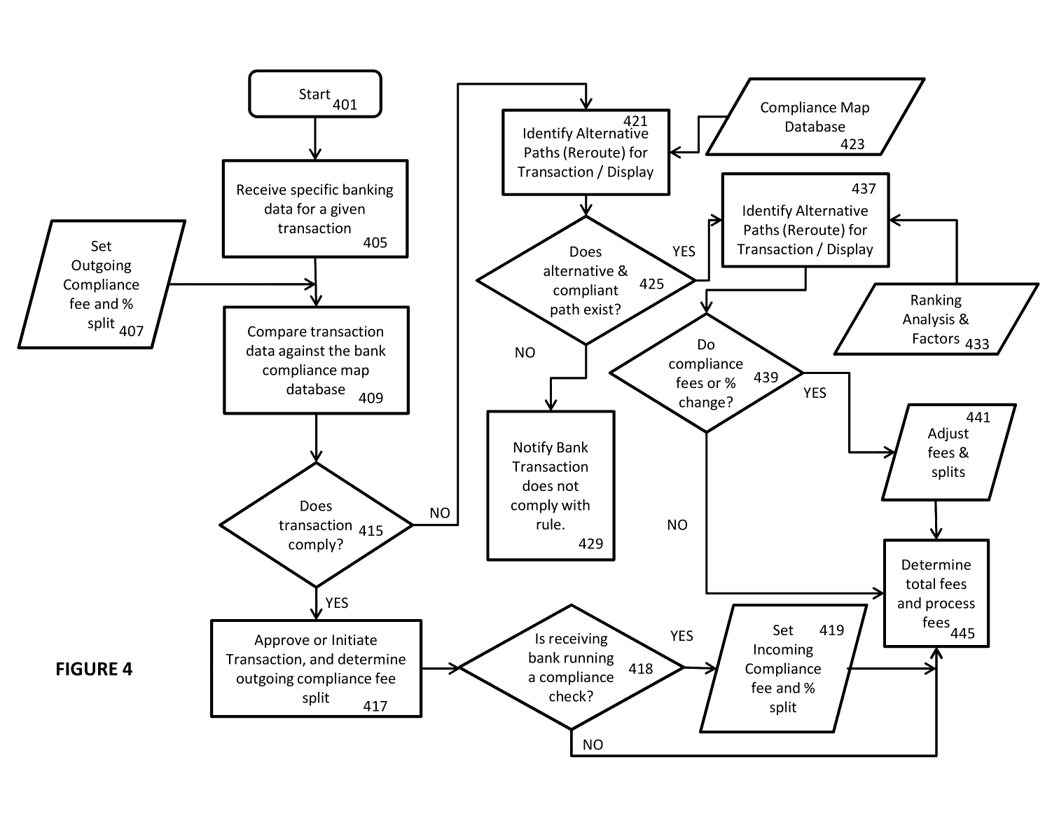

The system is also capable of identifying and determining any transaction fees related to the compliance check which the banking entities may employ. FIG. 4 provides a flow chart depicting the transaction fee aspects during a compliance review of a financial wire transaction. The software or application is initiated in step 401 and in step 405 the system receives specific banking data for a given financial transaction or batch of transactions. Such information would include the sending bank, the receiving bank, any preferred correspondent banks, the customer, the recipient, and the amount. The bank may set an outgoing compliance fee to be charged to the customer as well as any allocated percentage splits of the compliance checker fee in step 407. The splits may be splits with the entity providing the compliance software as well as any banking entities along the transaction path.

In step 409, the system compares the transaction data against the bank compliance map or database and determines one or more paths of correspondent banks the sending bank may use to conduct the wire transaction. Banks may establish various selection criteria to determine or select a preferred transaction path such as fewest touch points, preferred correspondent banks, lower fees, safest compliant path, or other factors. Once the preferred path is identified, the system then reviews the relationships of the correspondent banks and the recipient bank to determine if they have any relationships with, or how many degrees they are separated from, illicit banking entities.

In step 415 a determination is made as to whether the transaction complies with the bank defined rules for compliance (i.e. a minimum of 2 degrees of separation). Typically, this is preset to require all banks along the path must to be at least two degrees away from any illicit entity. Meaning, each bank along the path may not be doing business with or be in a correspondent relationship with an illicit entity. As previously mentioned, the system may display, approve and/or initiate the outgoing transaction along the approved path in step 417. In addition, the system may then allocate and determine the outgoing compliance fee split amongst the entities. By way of example, the transmitting bank may set a compliance fee of US $10 which it splits by keeping or retaining $4, allocating $4 to the entity which provides the compliance software; and $2 to be split equally by the number of correspondent banks along the transaction path.

The system, in step 418, can also review whether the receiving bank is also employing a compliance review and whether they are charging the recipient a compliance review fee. If they are employing a compliance check and charging a fee, the receiving bank would set their incoming compliance review fee and any percentage splits amongst the entities in step 419. If they are not employing a compliance check, or after the compliance fee and splits are assessed, the total fees and allocation of fees amongst entities can be determined in step 445.

If the software, in step 415, determines that the initial or preferred path of the transaction would not comply with the defined parameters, the system, in step 421, then identifies alternative paths using the compliance map database 423 and the banks correspondent banking network. The alternative paths are then also checked for compliance in step 425 to determine if one or more compliant paths exist. If no compliant paths exist, the system can notify the user that a compliant path does not exist in step 429. In such instance, the bank may elect to overrule the software and process the transaction anyway. The bank may also have rules in place as to how to handle fees, if any, for a terminated or rejected transaction.

If, in step 425, the software identifies one or more alternative paths that are compliant, those paths may be ranked in step 437 based on the rating calculation or based on one or more factors set by the bank such as and including fewest touch points, preferred banks, correspondent banking fees, safest compliant path, or other factors 433. The software then determines if the compliance fees or % change in step 439. Such changes might be required as some correspondent banks in the rerouted path or alternative path may have mandatory minimum fees which will alter the fee determinations and splits. If the fees change the system in step 441 adjusts the fees and splits amongst the entities. If the fees do not change, or after the fees and splits are adjusted, the total fees and allocation of fees amongst entities can be determined in step 445.

In addition to determining the fees in step 445, the software may also initiate the processing of such fees. Such processing may include automatically removing the fees from the wired amount of the financial transaction and allocating to the entities or to a bank account of the entities. Such fee processing may be direct removal or may simply be in the form of the generation and transmittal of instructions, such as through SWIFT instructions, to the transmitting and receiving bank on the amounts to deduct from the customer's account or recipient's account, or from the wired funds and the amounts and accounts of the appropriate entities receiving a split of fees.

In the preferred embodiment, the system would identify and rate all possible paths meeting a set criterion (i.e. not more than 6 banks in a transaction chain) as one continuous processing routine and would rank the paths based on their rating. The path with the highest rating or ranking would then be proposed as the preferred path. The user may be provided with alternative paths to select from based on the ratings and ranking

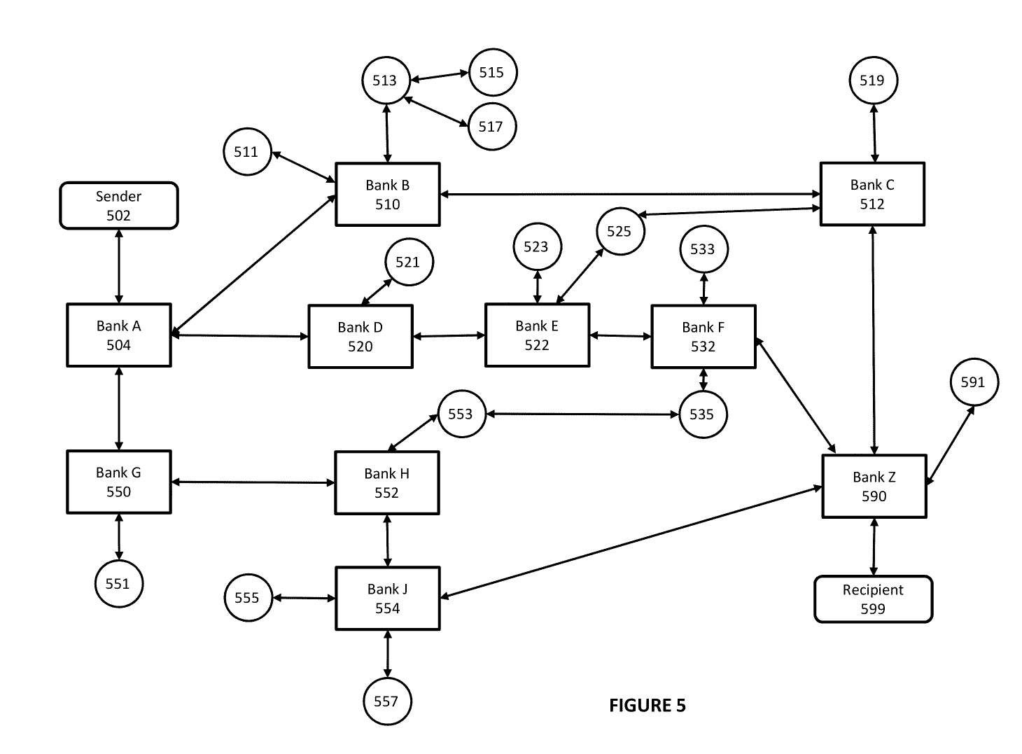

As seen in FIG. 5, and by way of example, a sender 502, who is a customer of a Bank A 504, wants to send money to a recipient 599 in a foreign country. The recipient 599 instructs the sender 502 to send the funds to Bank Z 590 where he has an account or can retrieve the funds. The system of the present invention is used by Bank A 504 to determine the various paths to send or transmit money to Bank Z 590 and remain in compliance with one or more banking regulations. The system determines Bank A 504 does not have a direct relationship with Bank Z 590 and must identify the paths or correspondent banking accounts which can accomplish the wire transaction.

For our example, the software of the present system determines there are three main paths to complete the transaction. The first main path goes from Bank A 504 to Bank B 510 to Bank C 512 to Bank Z 590. The second main path goes from Bank A 504 to Bank D 520 to Bank E 522 to Bank F 532 to Bank Z 590. The third path goes from Bank A 504 to Bank G 550 to Bank H 552 to Bank J 554 to Bank Z 590. However, the system also analyzes each path, the banks in the paths and the correspondent relationships of each bank in the path.

For the first main path, the system used by Bank A 504 reviews Bank B 510, Bank C 512, and Bank Z 590. The review of Bank B 504 includes a review of the correspondent banking relationships of Bank B 510 including their first degree of correspondent banks 511, 513. The review of Bank C 512 includes a review of the correspondent banking relationship Bank C 512 has with bank 519. The review of Bank Z 590 includes a review of the correspondent banking relationship Bank Z 590 has with bank 591. Banks 511, 513, 519, and 591 are considered two (2) degrees separated from the Bank A 504 transaction. If the system determines that any main bank 510, 512, 590 or any 2^{nd} degree bank 511, 513, 519, 591 are illicit entities the system will reject the path and seek alternative paths. The system would then review the second main path by reviewing Bank D 520, Bank E 522, Bank F 532, and Bank Z 590 and each of their correspondent banks 521, 523, 525, 533, 535, and 591. The system would then review the third main path by reviewing Bank G 550, Bank H 552, Bank J 554, and Bank Z 590 and each of their correspondent banks 551, 553, 555, 557, and 591.

The system of the present invention can also identify additional available paths using the correspondent banking relationships of banks in a path. For example, the system can identify a path from Bank A 504 to Bank G 550 to Bank H 552 to correspondent bank 553 to correspondent bank 535 to Bank F 532 to Bank Z 590. However, such long chains are likely to have a low rating or ranking due to an excessive number of banks in the path. Further, the system can also identify bridge banks which bridge different paths such as bank 525 which could be used to bridge or move from path 1 to path 2 should there be a problematic relationship (i.e. such as the system determining that Bank F 532 has a relationship with an illicit bank). In such a scenario, bank 525 could be used to bridge a path from Bank E 522 to Bank C 512. As previously indicated, the system can identify the paths and based on the rating score previously discussed the system can rate each path and then rank the available paths.

Further, the system can include a review of correspondent banks with additional degrees of separation such as banks that are three (3) degrees of separation from Bank A 504 or from the path of the transaction. For example, a review of Bank B 510 includes a review of the correspondent banking relationships with banks 511, 513. The system can then review the database to identify the relationships of bank 513 and identify that bank 513 has correspondent relationships with banks 515 and 517. Banks 515 and 517 are considered three (3) degrees separated from Bank A 504. The system can process the relationships of any bank on the path to a 2^{nd} or 3^{rd} degree (or higher) to identify any relationships with illicit entities as part of the compliance review.

By way of example, if the system has identified banks 515, 522, and 535 as being illicit banking entities the system can then review each of the paths. The system would determine that Bank B 510, Bank C 512, and Bank Z 590 are not in a direction correspondent banking relationships with any illicit banking entity. Therefore, if the system criterion is set to approve paths if there are no illicit entities within 2 degrees of separation then path 1 would be deemed compliant. The system would determine that path 2 is not compliant because Bank E 522 has been identified as an illicit banking entity. Path 3 would also be deemed to be compliant since Bank G 550, Bank H 552, Bank J 554, and Bank Z 590 do not have any direct relationships with an illicit banking entity.

However, path 1 and path 3 are not likely to have the same rating score or ranking First, the system would determine that path 1 only has 3 links in the path while path 3 has 4 links in its path. Thus, the system might determine path 1 to be in compliance with the highest rating. However, the system may also take fees into consideration and might find that Bank C 512 has excessive fees for acting as a correspondent bank on wired transactions. The excessive fees of Bank C 512 might downgrade the rating of path 1 which would allow or move path 3 to rate and rank higher even though it has more links in the path. The system, by comparing the various available paths, the correspondent relationships of each bank in the path, the degrees of separation, and the fees of each bank in the path can provide a system which minimizes risk by keeping transactions within compliance while also lowering fees for the bank utilizing the system.

The system of the present invention may also map and display the various paths, banks, and correspondent banks on a display in connection with the system. Such might be at the server or transmitted to the display of the remote user. Such display might look like FIG. 5 with the inclusion of bank details and might make use of color and shading to identify the highest rated paths and alternative paths. Further, the display might identify the illicit entities to showcase why certain paths are not available.

Further, the processing of fees may be done on a one off transaction or a batch of transactions. Still further, the fees transmitted from entity to entity, or more specifically the instructions for the deduction of fees from the customer's account may be conducted per transaction or in batch transactions. Batch transactions may run at a set time interval such as hourly, daily, weekly, monthly, quarterly or some other set interval such when the total number of transactions waiting to be processed reaches 10 or more. In addition, the system could be employed with a standard flat fee per transaction or per compliance review and the system would keep a running log or counter of the number of processes or transactions it reviewed and would charge the banking entities a fee (i.e. $1 per transaction). Banks would then pay the software compliance entity and other banking entity fees based on completed transaction or compliance reviews.

Through use of the software and correspondent banking relationship map and compliance database, the present invention provides a compliance review system and method which can verify compliance of a financial transaction against banks doing business, either direct or indirect, with illicit banking entity regulations. The software is capable of determining and initiating compliance fees amongst entities involved. Such initiation may be in the form of instructions of logs or records to determine fee splits and payments. Fees may be deducted from funds sent, funds received, customer accounts, or paid by the banking entities directly.

The software can determine the fee splits and adjust fees or fee splits in the event of a path reroute. The system can also rank paths and rerouted or alternative paths based on various factors include correspondent bank fees and/or any percentage splits of a compliance fee. The system can initiate fund or fee transfers to specific accounts of the entities receiving a portion of fees, can initiate instructions transmitted with the financial transaction notifying the sending and receiving bank entities the amount of fees to allocate to the various entities, their accounts, or their accounts log or records.

The present invention can also incorporate additional data elements to layer into or on top of the correspondent banking relationship data. Such additional data elements might include OFAC data and PEP (politically exposed person) data. PEPs and Senior Foreign Political Figure are often used interchangeably as terms describing someone with a prominent public function or an individual who is closely related to such a person. PEPs generally present a higher risk for potential involvement in corruption and most financial institutions view such clients as compliance risks. By monitoring PEPs and their relationships and accounts with the various banks, banking institutions can avoid conducting business with other banking institutions which present such compliance risks (i.e. avoid transacting with or transmitting funds through high risk banks doing business with PEPs or banks doing business with banks doing business with PEPs).

The present invention can also be used to identify new correspondent banking relationships and transaction paths which achieve a specified goal or results. By way of example, a bank may decide it wants to avoid all financial transactions which may go through a certain country (i.e. transact through an account or bank or bank branch in a given country or territory). For example, a bank may identify that a certain country or territory has significant non-compliance risks, or that many banking entities in the country or territory are suspected of illicit activities and the bank would prefer to avoid entities within the country. In such instances, the bank may set the system to restrict or reject paths which touch entities within the user restricted areas. The user may also restrict paths with any correspondent banks of the bank entities within those countries (i.e. 2 degrees separated from the avoided territory). By employing such a system, banks can start to direct transaction paths to minimize interaction with entities in a territory, or exposure to the laws and sanctions of a given territory.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A system of determining compliant paths for financial transactions comprising:
a. at least one computer;
b. at least one database in communication with the at least one computer;
c. at least one software application resident on the computer, wherein the at least one software application is configured to:
d. receive information on a financial transaction which includes a transaction from a first banking entity to a second banking entity wherein the first banking entity and second banking entity do not have a direct correspondent banking relationship;
e. analyze a correspondent banking database to identify at least one path of correspondent banking relationships connecting the first banking entity to the second banking entity;
f. review each bank in the at least one path against an illicit banking compliance list;
g. review each correspondent banking relationship of each bank in the at least one path to identify each of a plurality of correspondent banks and reviewing each of the plurality of identified correspondent banks against the illicit banking compliance list; and
h. approving the at least one path if each bank in the at least one path and each correspondent bank of each bank in the at least one path are not on the illicit banking compliance list.

2. The system of claim 1, wherein the software of the system determines a rating score for each of the at least one paths.

3. The system of claim 2, wherein the software ranks each path based on the rating score.

4. The system of claim 1, wherein the system displays the at least one path to the user.
